(19) United States
(12) Patent Application Publication
(10) Pub. No.: US 2026/0238060 A1
(43) Pub. Date: Aug. 13, 2026

(54) ELECTRIC MOTOR ASSEMBLY HAVING A BUSBAR THAT DEFINES APERTURES

(71) Applicant: Schaeffler Technologies AG & Co. KG, Herzogenaurach (DE)

(72) Inventor: Vishal Jadhav, Kent, OH (US)

(73) Assignee: Schaeffler Technologies AG & Co. KG, Herzogenaurach (DE)

(21) Appl. No.: 19/052,483

(22) Filed: Feb. 13, 2025

(51) Int. Cl. H02K 3/28; H02K 3/50; H02K 15/34

(52) U.S. Cl. CPC H02K 3/28; H02K 3/50; H02K 15/34; H02K 2203/09

(57) ABSTRACT

An electric motor assembly includes a stator that a rotor rotates relative to about an axis. The stator includes a stator core that extends axially in a first axial direction from a first axial end to a second axial end opposite the first axial end. A plurality of windings extend along the stator core, each of which respectively includes a terminal end that is positioned axially beyond the second axial end of the stator core in the first axial direction. A busbar defines at least one aperture within which at least one of the plurality of windings extends.

### FIELD OF THE DISCLOSURE

The present disclosure generally relates to an electric motor assembly. More specifically, the present disclosure relates to an electric motor assembly that includes a stator having a plurality of windings and a busbar that defines at least one aperture configured to receive at least one winding therein.

### BACKGROUND OF THE DISCLOSURE

Electric motors often include windings that are fixed to busbars. During operation of these electric motors, forces may be applied to the windings that cause stress at the connection points between the windings and the busbar.

### SUMMARY OF THE DISCLOSURE

According to a first aspect of the present disclosure, an electric motor assembly includes a stator and a rotor that rotates relative to the stator about an axis. The stator includes a stator core that extends axially in a first axial direction from a first axial end to a second axial end opposite the first axial end. A plurality of windings extend along the stator core, each of which respectively includes a terminal end that is positioned axially beyond the second axial end of the stator core in the first axial direction. A busbar defines at least one aperture within which at least one of the plurality of windings extends.

Embodiments of the first aspect of the disclosure can include any one or a combination of the following features:
the at least one aperture extends from a first opening to a second opening, and the at least one winding of the plurality of windings extends through the at least one aperture, into the first opening and out of the second opening;
the at least one aperture includes at least one inner aperture defined by the busbar, and at least one outer aperture that is defined by the busbar and positioned radially outboard of the at least one inner aperture;
the at least one winding of the plurality of windings includes at least one inner winding that extends within the at least one inner aperture defined by the busbar and at least one outer winding that extends within the at least one outer aperture defined by the busbar;
the at least one inner aperture comprises a plurality of inner apertures, the at least one outer aperture comprises a plurality of outer apertures, the at least one inner winding comprises a plurality of inner windings that respectively extend through the corresponding plurality of inner apertures, and the at least one outer winding comprises a plurality of outer windings that respectively extend through the corresponding plurality of outer apertures;
the busbar is a first busbar, and a second busbar is in a spaced relationship with the first busbar, the second busbar defining at least one aperture within which at least one of the plurality of windings extends;
the busbar is a neutral busbar; and
the at least one winding of the plurality of windings is welded to the busbar.

According to a second aspect of the present disclosure, a busbar for an electric motor assembly includes a body that defines at least one aperture that is configured to receive at least one winding of a stator of the electric motor assembly therein.

Embodiments of the second aspect of the disclosure can include any one or a combination of the following features:
the at least one aperture comprises at least one inner aperture defined by the body and at least one outer aperture that is defined by the body and positioned radially outboard of the at least one inner aperture;
the at least one inner aperture comprises a plurality of inner apertures, and the at least one outer aperture comprises a plurality of outer apertures, each of the plurality of outer apertures being radially outboard of each of the plurality of inner apertures; and
the body is configured to be neutral in the electric motor assembly.

According to a third aspect of the present disclosure, a method of manufacturing a portion of an electric motor assembly includes the steps of: providing a stator that includes a stator core and a plurality of windings that extend along the stator core, each of which respectively includes a terminal end; and assembling a busbar that defines at least one aperture to the stator, such that at least one winding of the plurality of windings extends within the at least one aperture defined by the busbar.

Embodiments of the third aspect of the disclosure can include any one or a combination of the following steps or features:
a step of fixing the at least one winding to the busbar;
the step of fixing the at least one winding to the busbar comprises welding the at least one winding to the busbar;
the at least one aperture extends from a first opening to a second opening, and wherein the step of assembling the busbar comprises inserting the at least one winding through the at least one aperture, into the first opening and out of the second opening;
the at least one aperture comprises at least one inner aperture defined by the busbar and at least one outer aperture that is defined by the busbar and positioned radially outboard of the at least one inner aperture;
the at least one winding comprises at least one inner winding and at least one outer winding, wherein the step of assembling the busbar comprises inserting the at least one inner winding through the at least one inner aperture and inserting the at least one outer winding through the at least one outer aperture;
the at least one inner aperture comprises a plurality of inner apertures, the at least one outer aperture comprises a plurality of outer apertures, the at least one inner winding comprises a plurality of inner windings, and the at least one outer winding comprises a plurality of outer windings, and wherein the step of assembling the busbar comprises inserting the plurality of inner windings through the corresponding plurality of inner apertures, respectively, and inserting the plurality of outer windings through the corresponding plurality of outer apertures, respectively; and
the busbar is a neutral busbar.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a cross-sectional view of an electric drive unit that includes an electric motor assembly that has a stator and a rotor, according to one embodiment;

FIG. 2 is a perspective view of a portion of an electric motor assembly, illustrating a stator that includes a plurality of windings and a plurality of busbars to which the plurality of windings are fixed, to one embodiment;

FIG. 3 is a perspective view of a portion of an electric motor assembly, according to one embodiment;

FIG. 4 is a side elevational view of a portion of the electric motor assembly, illustrating a busbar and a plurality of windings respectively received within a corresponding plurality of apertures defined by the busbar, according to one embodiment;

FIG. 5 is a cross-sectional view of a portion of FIG. 4 taken at line V-V, illustrating a busbar that defines apertures and windings extending through the apertures, according to one embodiment; and

FIG. 6 is a flow diagram illustrating the steps of a method of manufacturing a portion of an electric motor assembly, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis about which a component (e.g., rotor) is configured to rotate in operation of the apparatus described herein. Further, the term “radial” and derivatives thereof, such as “radially,” shall be understood in relation to the axis of the aforementioned component. For example, “radially outboard” refers to further away from the axis, while “radially inboard” refers to nearer to the axis. The term “circumferential” and derivatives thereof, such as “circumferentially,” shall be understood in relation to the axis of the aforementioned component.

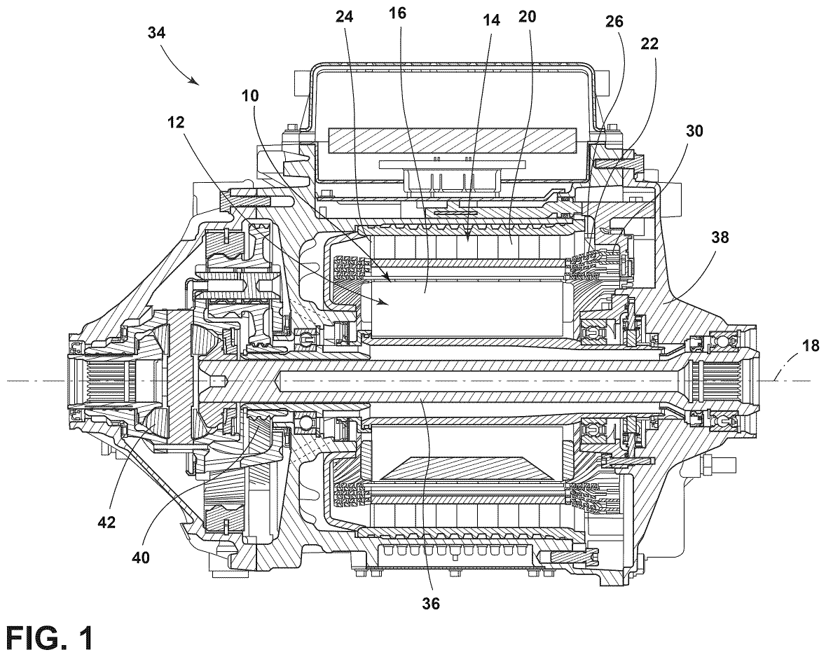

Referring now to FIGS. 1-6, an electric motor assembly 10 includes a motor 12 having a stator 14 that a rotor 16 rotates relative to about an axis 18. The stator 14 includes a stator core 20 and a plurality of windings 22. The stator core 20 extends axially in a first axial direction from a first axial end 24 to a second axial end 26 opposite the first axial end 24. The plurality of windings 22 extend along the stator core 20. Each of the plurality of windings 22 respectively includes a terminal end 28 that is positioned axially beyond the second axial end 26 of the stator core 20 in the first axial direction. The electric motor assembly 10 includes a busbar 30 that defines at least one aperture 32. At least one winding 22 of the plurality of windings 22 extends within the at least one aperture 32.

Referring now to FIG. 1, the electric motor assembly 10 may be a portion of an electric drive unit 34 for a vehicle, as illustrated in FIG. 1. The electric motor assembly 10 includes the rotor 16 and the stator 14 that is disposed radially outboard of the rotor 16. As illustrated in FIG. 1, a rotor shaft 36 may be positioned radially inboard of the rotor 16 and may be configured to rotate about the axis 18 during operation of the electric motor assembly 10. The electric drive unit 34 may include a variety of other components, including a housing 38 that houses the motor 12, a gearset 40 operably coupled with the rotor shaft 36, and/or a differential 42 operably coupled with the gearset 40.

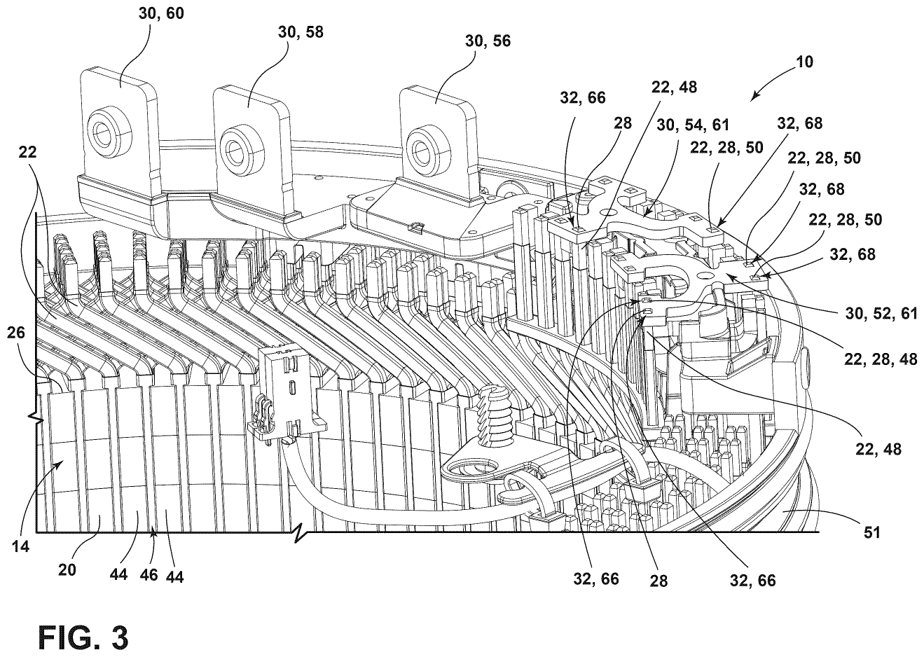

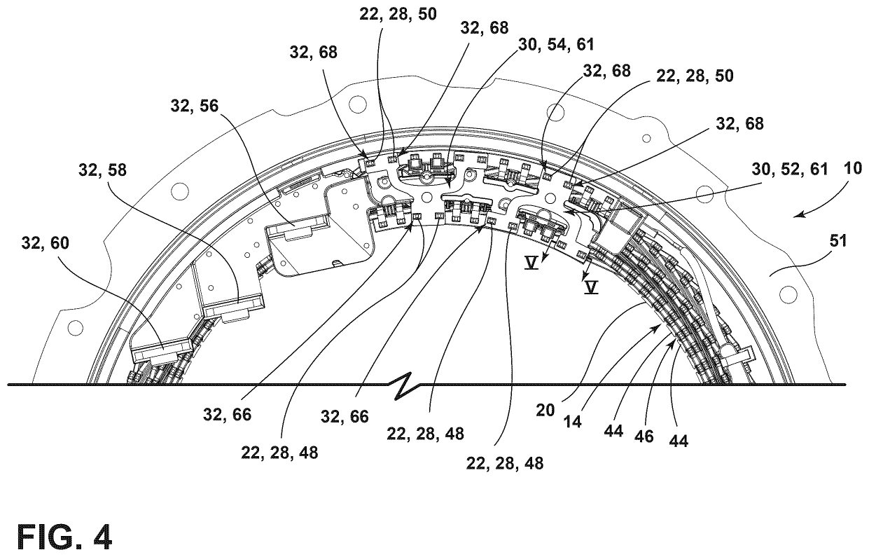

Referring now to FIGS. 1-4, the stator 14 of the electric motor assembly 10 includes the stator core 20. As illustrated in FIGS. 1-3, the stator core 20 extends axially in the first axial direction from the first axial end 24 of the stator core 20 to the second axial end 26 of the stator core 20 that is opposite the first axial end 24. As illustrated in FIG. 3, the stator core 20 can include a plurality of teeth 44 that are circumferentially spaced apart to define a plurality of gaps 46 between adjacent teeth 44. The stator 14 further includes the plurality of windings 22. The plurality of windings 22 extend along the stator core 20. In various implementations, the windings 22 extend within the gaps 46 defined between adjacent teeth 44 of the stator core 20, as illustrated in FIG. 3. Each of the windings 22 includes a terminal end 28 that is positioned axially beyond the second axial end 26 of the stator core 20 in the first axial direction. In various embodiments, the plurality of windings 22 of the stator 14 includes at least one inner winding 48 and at least one outer winding 50, the terminal end 28 of which is positioned radially outboard of the terminal end 28 of the at least on inner winding 48. As illustrated in FIG. 4, the at least one inner winding 48 can include a plurality of inner windings 48 and the at least one outer winding 50 can include a plurality of outer windings 50. As described further herein, the windings 48, 50 may be fixed to the busbar 30 proximate the terminal ends 28 of the windings 48, 50. As illustrated in FIGS. 1-4, a stator carrier 51 can extend circumferentially about the stator 14 radially-outboard of the stator 14, in various embodiments.

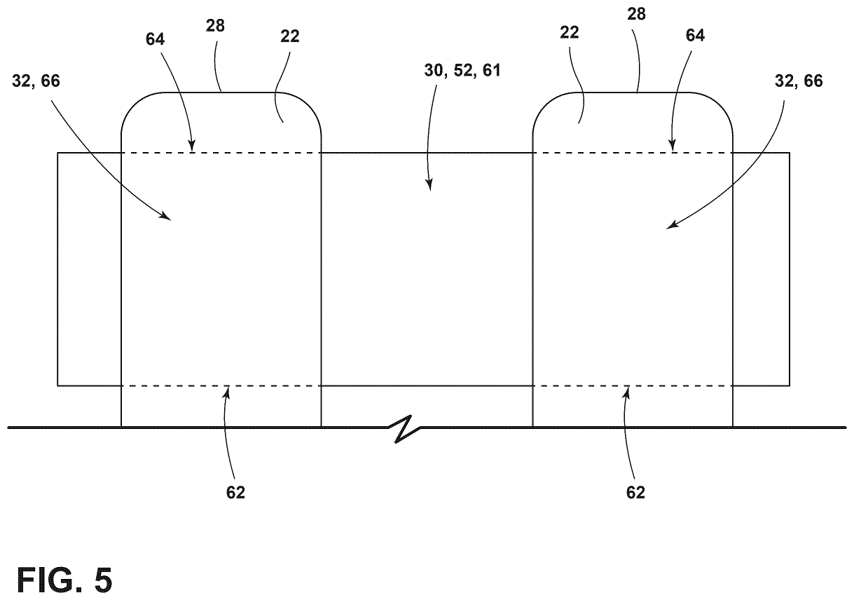

Referring still to FIGS. 1-4, the electric motor assembly 10 includes the busbar 30. In various implementations, the electric motor assembly 10 includes a plurality of busbars 30. For example, as illustrated in FIG. 5, the electric motor assembly 10 includes a first busbar 52, a second busbar 54, a third busbar 56, a fourth busbar 58, and a fifth busbar 60. In the exemplary embodiment illustrated in FIG. 3, the first and second busbars 52, 54 are neutral, the third busbar 56 is U-phase, the fourth busbar 58 is V-phase, and the fifth busbar 60 is W-phase. It is contemplated that various numbers of busbars can be included in the electric motor assembly 10, and the busbars may be associated with various phases, in some embodiments.

Referring now to FIGS. 1-5, the busbar 30 of the electric motor assembly 10 defines at least one aperture 32. In various implementations, the busbar 30 includes a body 61, and the body 61 of the busbar 30 defines the at least one aperture 32. As illustrated in FIGS. 3-5, the busbar 30 defines a plurality of apertures 32. The at least one aperture 32 extends through the busbar 30 from a first opening 62 to a second opening 64. As illustrated exemplarily in FIG. 5, the busbar 30 defines a plurality of apertures 32, each of which extends from a corresponding first opening 62 to a corresponding second opening 64 that is axially offset from the first opening 62. In some implementations, the busbar 30 defines at least one inner aperture 66 and at least one outer aperture 68. The at least one outer aperture 68 is positioned radially outboard of the at least one inner aperture 66. In some embodiments, the at least one inner aperture 66 comprises a plurality of inner apertures 66, and/or the at least one outer aperture 68 comprises a plurality of outer apertures 68. For example, as illustrated in FIG. 4, the busbar 30 defines a plurality of inner apertures 66 and a plurality of outer apertures 68 disposed radially-outboard of the plurality of inner apertures 66.

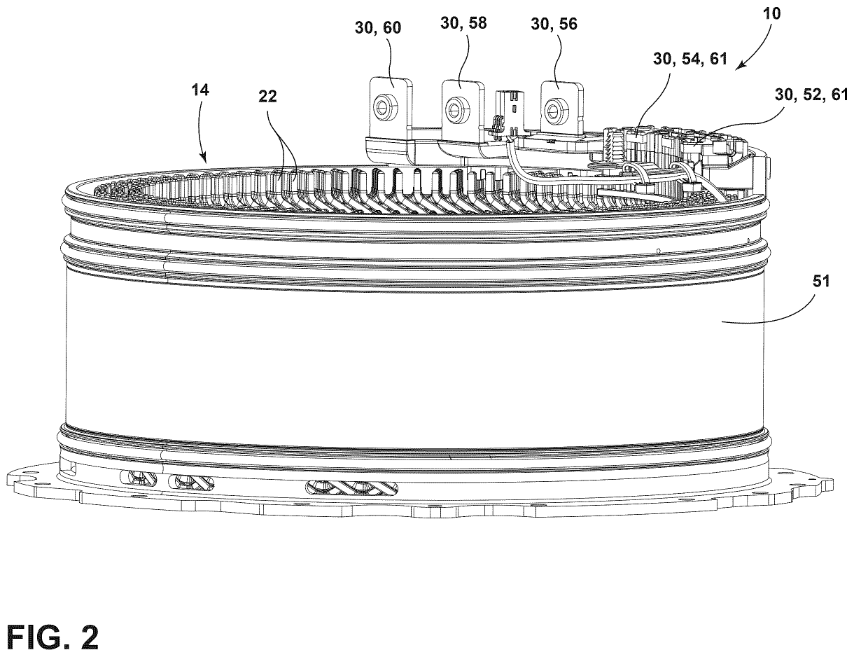

Referring now to FIGS. 2-5, in various implementations, the at least one winding 22 of the plurality of windings 22 is received within the at least one aperture 32 defined by the busbar 30 of the electric motor assembly 10. In some embodiments, wherein the busbar 30 defines at least one inner aperture 66 and at least one outer aperture 68, at least one inner winding 48 is received within the at least one inner aperture 77, and at least one outer winding 50 is received within the at least one outer aperture 68. For example, in the embodiment illustrated in FIGS. 4 and 5, a plurality of inner windings 48 are respectively received through a corresponding plurality of inner apertures 66 defined by the busbar 30, such that the windings 48 extend into the first openings 62 and out of the second openings 64 of the apertures 66, 68, respectively. Further, a plurality of outer windings 50 are respectively received through a corresponding plurality of outer apertures 68 defined by the busbar 30 in similar fashion.

Referring still to FIGS. 2-5, the at least one winding 22 is fixed to the one or more busbars 30. In various implementations, the at least one winding 22 is fixed to the one or more busbars 30 proximate to the terminal end 28 of the at least one winding 22. In some implementations, wherein the at least one winding 22 extends within the at least one aperture 32 defined by the busbar 30, the at least one winding 22 is fixed to the busbar 30 at the portion of the busbar 30 that defines the at least one aperture 32. For example, the at least one winding 22 may be welded to the busbar 30 at or proximate to the portion of the busbar 30 that defines the at least one aperture 32 within which the at least one winding 22 is received, as illustrated in FIG. 5. The at least one winding 22 may be fixed to the busbar 30 in a variety of manners. For example, in some implementations, the at least one winding 22 can be fixed to the busbar 30 via a conductive adhesive.

Referring now to FIGS. 1-5, in an exemplary embodiment of the electric motor assembly 10, the electric motor assembly 10 includes first, second, third, fourth, and fifth busbars 52, 54, 56, 58, 60. The first and second busbars 52, 54 are neutral and in a spaced relationship with each other, the third busbar 56 is U-phase, the fourth busbar 58 is V-phase, and the fifth busbar 60 is W-phase. The first and second busbars 52, 54 respectively define pluralities of inner and outer apertures 66, 68. The stator of 14 the electric motor assembly 10 includes a plurality of windings 22 that includes a plurality of inner windings 48 and a plurality of outer windings 50. Each inner winding 48 in a first sub-plurality of the plurality of inner windings 48 extends through a respective corresponding inner aperture 66 defined by the first busbar 52, and each outer winding 50 in a first sub-plurality of the plurality of outer windings 50 extends through a respective corresponding outer aperture 68 defined by the first busbar 52. Further, each inner winding 48 in a second sub-plurality of the plurality of inner windings 48 extends through a respective corresponding inner aperture 66 defined by the second busbar 54, and each outer winding 50 in a second sub-plurality of the plurality of outer windings 50 extends through a respective corresponding outer aperture 68 defined by the second busbar 54. The windings 48, 50 are fixed to the busbars 52-60 via welding.

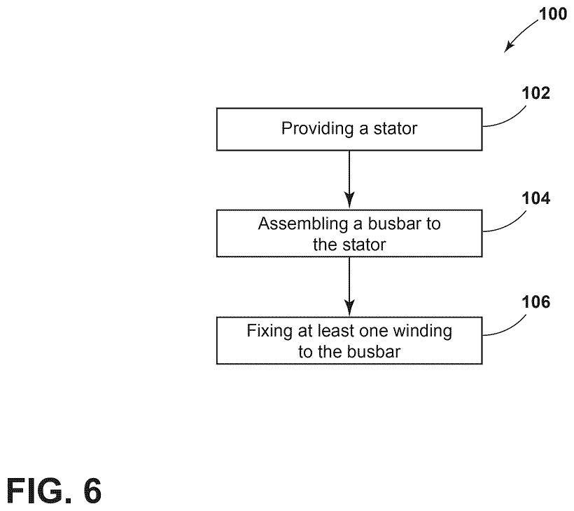

Referring now to FIG. 6, a method 100 of manufacturing a portion of the electric motor assembly 10 includes a step 102 of providing the stator 14. The stator 14 can include the stator core 20 and the plurality of windings 22 that extend along the stator core 20. Each of the windings 22 can include a terminal end 28.

The method 100 further includes a step 104 of assembling the busbar 30 to the stator 14. The busbar 30 that is assembled to the stator 14 at step 104 defines at least one aperture 32. In various implementations, at step 104, the busbar 30 is assembled to the stator 14, such that at least one winding 22 of the plurality of windings 22 extends within the at least one aperture 32 defined by the busbar 30. In various implementations, wherein the at least one aperture 32 extends from the first opening 62 to the second opening 74, the step 104 comprises inserting the at least one winding 22 through the at least one aperture 32, into the first opening 62 and out of the second opening 64. In some implementations, the step 104 comprises inserting at least one inner winding 48 through at least one inner aperture 66 and/or inserting at least one outer winding 50 through at least one outer aperture 68. In some implementations, the step 104 comprises inserting a plurality of inner windings 48 through a corresponding plurality of inner apertures 66, respectively, and inserting a plurality of outer windings 50 through a corresponding plurality of outer apertures 68, respectively.

Referring still to FIG. 5, the method 100 can include a step 106 of fixing at least one winding 22 to the busbar 30. In various implementations, the step 106 of fixing the at least one winding 22 to the busbar 30 comprises welding the at least one winding 22 to the busbar 30. In some implementations, the at least one winding 22 can be fixed to the busbar 30 in another or an additional manner. For example the at least one winding 22 can be fixed to the busbar 30 via one or more of a variety of manners that includes but is not limited to welding, staking, soldering, brazing, mechanical fixation, adhering, clamping, riveting, thermal joining, rigid bonding, and/or a combination thereof.

The electric motor assembly 10 of the present disclosure may provide a variety of advantages. For example, the busbar 30 including the at least one aperture 32 and the at least one winding 22 being received within the at least one aperture 32 and then fixed to the busbar 30 may mitigate the consequences of stresses that may otherwise cause disconnection of the at least one winding 22 from the busbar 30.

It is to be understood that variations and modifications can be made on the aforementioned structure without departing from the concepts of the present disclosure, and further it is to be understood that such concepts are intended to be covered by the following claims unless these claims by their language expressly state otherwise.

### List of Reference Numerals

electric motor
10 assembly
12 motor
14 stator
16 rotor
18 axis
20 stator core
22 windings
24 first axial end
26 second axial end
28 terminal end
30 busbar
32 aperture
34 electric drive unit
36 rotor shaft
38 housing
40 gearset
42 differential
44 teeth
46 gaps
48 inner winding
50 outer winding
51 stator carrier
52 first busbar
54 second busbar
56 third busbar
58 fourth busbar
60 fifth busbar
61 body
62 first opening
64 second opening
66 inner aperture
68 outer aperture
0 method
2 step
4 step
6 step

What is claimed is:

1. An electric motor assembly, comprising:
a stator that a rotor rotates relative to about an axis, the stator comprising:
a stator core that extends axially in a first axial direction from a first axial end to a second axial end opposite the first axial end; and
a plurality of windings that extend along the stator core, each of which respectively includes a terminal end that is positioned axially beyond the second axial end of the stator core in the first axial direction; and
a busbar defining at least one aperture within which at least one of the plurality of windings extends.

2. The electric motor assembly of claim 1, wherein the at least one aperture extends from a first opening to a second opening, and the at least one winding of the plurality of windings extends through the at least one aperture, into the first opening and out of the second opening.

3. The electric motor assembly of claim 1, wherein the at least one aperture comprises:
at least one inner aperture defined by the busbar; and
at least one outer aperture that is defined by the busbar and positioned radially outboard of the at least one inner aperture.

4. The electric motor assembly of claim 3, wherein the at least one winding of the plurality of windings comprises:
at least one inner winding that extends within the at least one inner aperture defined by the busbar; and
at least one outer winding that extends within the at least one outer aperture defined by the busbar.

5. The electric motor assembly of claim 4, wherein the at least one inner aperture comprises a plurality of inner apertures, the at least one outer aperture comprises a plurality of outer apertures, the at least one inner winding comprises a plurality of inner windings that respectively extend through the corresponding plurality of inner apertures, and the at least one outer winding comprises a plurality of outer windings that respectively extend through the corresponding plurality of outer apertures.

6. The electric motor assembly of claim 1, wherein the busbar is a first busbar, and the electric motor assembly comprises:
a second busbar in a spaced relationship with the first busbar, the second busbar defining at least one aperture within which at least one of the plurality of windings extends.

7. The electric motor assembly of claim 1, wherein the busbar is a neutral busbar.

8. The electric motor assembly of claim 1, wherein the at least one winding of the plurality of windings is welded to the busbar.

9. A busbar for an electric motor assembly, comprising:
a body that defines at least one aperture that is configured to receive at least one winding of a stator of the electric motor assembly therein.

10. The busbar of claim 9, wherein the at least one aperture comprises:
at least one inner aperture defined by the body; and
at least one outer aperture that is defined by the body and positioned radially outboard of the at least one inner aperture.

11. The busbar of claim 10, wherein the at least one inner aperture comprises a plurality of inner apertures, and the at least one outer aperture comprises a plurality of outer apertures, each of the plurality of outer apertures being radially outboard of each of the plurality of inner apertures.

12. The busbar of claim 9, wherein the body is configured to be neutral in the electric motor assembly.

13. A method of manufacturing a portion of an electric motor assembly, comprising the steps of:
providing a stator that includes a stator core and a plurality of windings that extend along the stator core, each of which respectively includes a terminal end; and
assembling a busbar that defines at least one aperture to the stator, such that at least one winding of the plurality of windings extends within the at least one aperture defined by the busbar.

14. The method of claim 13, further comprising the step of:
fixing the at least one winding to the busbar.

15. The method of claim 14, wherein the step of fixing the at least one winding to the busbar comprises welding the at least one winding to the busbar.

16. The method of claim 13, wherein the at least one aperture extends from a first opening to a second opening, and wherein the step of assembling the busbar comprises inserting the at least one winding through the at least one aperture, into the first opening and out of the second opening.

17. The method of claim 13, wherein the at least one aperture comprises:
at least one inner aperture defined by the busbar; and
at least one outer aperture that is defined by the busbar and positioned radially outboard of the at least one inner aperture.

18. The method of claim 17, wherein the at least one winding comprises:
at least one inner winding; and
at least one outer winding, wherein the step of assembling the busbar comprises inserting the at least one inner winding through the at least one inner aperture and inserting the at least one outer winding through the at least one outer aperture.

19. The method of claim 18, wherein the at least one inner aperture comprises a plurality of inner apertures, the at least one outer aperture comprises a plurality of outer apertures, the at least one inner winding comprises a plurality of inner windings, and the at least one outer winding comprises a plurality of outer windings, and wherein the step of assembling the busbar comprises inserting the plurality of inner windings through the corresponding plurality of inner apertures, respectively, and inserting the plurality of outer windings through the corresponding plurality of outer apertures, respectively.

20. The method of claim 13, wherein the busbar is a neutral busbar.
